(19) United States
(12) Patent Application Publication
(10) Pub. No.: US 2019/0279085 A1
(43) Pub. Date: Sep. 12, 2019

(54) LEARNING METHOD, LEARNING DEVICE, AND COMPUTER-READABLE RECORDING MEDIUM

(71) Applicant: FUJITSU LIMITED, Kawasaki-shi (JP)

(72) Inventor: YUHEI UMEDA, Kawasaki (JP)

(73) Assignee: FUJITSU LIMITED, Kawasaki-shi (JP)

(21) Appl. No.: 16/286,638

(22) Filed: Feb. 27, 2019

(30) Foreign Application Priority Data
Mar. 9, 2018 (JP) 2018-043605

(51) Int. Cl. G06N 3/08; G06N 20/00; G06F 17/15

(52) U.S. Cl. CPC G06N 3/08; G06F 17/15; G06N 20/00

(57) ABSTRACT

A non-transitory computer-readable recording medium stores therein a learning program that causes a computer to execute a process including: setting a label vector having one or a plurality of labels as components to corresponding data to be learned ; and learning a learning model including a neural network using the data to be learned and the label vector correspondingly set to the data to be learned.

### CROSS-REFERENCE TO RELATED APPLICATION

This application is based upon and claims the benefit of priority of the prior Japanese Patent Application No. 2018-043605, filed on Mar. 9, 2018, the entire contents of which are incorporated herein by reference.

### FIELD

The embodiments discussed herein are related to a computer-readable recording medium, a learning method, and a learning device.

### BACKGROUND

There has been known supervised learning using labeled data. In the supervised learning, labeling is exclusive. For example, if a label is a label 1, the label is not the other labels. However, a condition in which exclusive labeling is generally impossible also exists. For example, when a label indicating that a person likes dogs or cats is given, a person who likes both dogs and cats exists. If labeling is performed on only either one in order to make the labeling exclusive, data is not preferable as data to be learned.

In recent years, there has been known a technique where labeling is exclusively performed using a classifier and label conversion even under a condition where labels are not exclusively given. There has been known a technique for generating a classifier with respect to each of the N labels such as a binary discriminative classifier of whether to be applicable to a label 1 and a binary discriminative classifier of whether to be applicable to a label 2.

There has been known a technique where a combination for each label is defined as a new label. FIG. 11 is a diagram illustrating exclusive label conversion. As illustrated in FIG. 11, a new label a is given to data that is applicable to all of the labels 1, 2, and 3. A new label b is given to data that is applicable to the labels 1 and 2, but is not applicable to the label 3. A new label c is given to data that is applicable to the labels 1 and 3, but is not applicable to the label 2. In this manner, learning data where a new label is given for each combination of labels is generated. (See Japanese Laid-open Patent Publication No. 2015-166962 and Japanese Laid-open Patent Publication No. 2017-016414.)

However, in the techniques described above, aggregating labels causes deterioration in determination speed and deterioration in determination accuracy of a learning result to occur, and causes learning accuracy to be deteriorated. For example, in the method for generating a classifier, classifiers are needed for the number of labels, thereby increasing a calculation time and increasing an identification time.

In the method for giving a new label, with respect to the original number of labels n, the number of labels is the number of labels of the n-th power of 2, and exponentially increases. Thus, the number of learning data needed for learning becomes huge and a learning time also becomes huge. As illustrated in FIG. 11, if a ratio of data that is applicable to each label in all of the data and a ratio of each label are processed equivalently, wrong learning may be facilitated and learning accuracy is deteriorated.

### SUMMARY

According to an aspect of an embodiment, a non-transitory computer-readable recording medium stores therein a learning program that causes a computer to execute a process including: setting a label vector having one or a plurality of labels as components to corresponding data to be learned; and learning a learning model including a neural network using the data to be learned and the label vector correspondingly set to the data to be learned.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating a whole example of a learning device in accordance with a first embodiment;

FIG. 2 is a functional block diagram illustrating the functional configuration of the learning device in accordance with the first embodiment;

FIG. 3 is a diagram illustrating an example of information stored in a learning data database (DB);

FIG. 4 is a view illustrating the correlation between labels;

FIGS. 5A, 5B, and 5C are views illustrating an example of label settings;

FIG. 6 is a view illustrating an example of generating label vectors;

FIG. 7 is a view illustrating another example of label settings;

FIG. 8 is a flowchart illustrating a flow of processing;

FIG. 9 is a diagram illustrating the experiment results;

FIG. 10 is a diagram illustrating a hardware configuration example; and

FIG. 11 is a diagram illustrating exclusive label conversion.

### DESCRIPTION OF EMBODIMENTS

Preferred embodiments will be explained with reference to accompanying drawings. The embodiments are not intended to limit the scope of this invention. Each of the embodiments may be combined as appropriate in the range where no inconsistency occurs in processing contents.

### [a] First Embodiment

### Whole Configuration

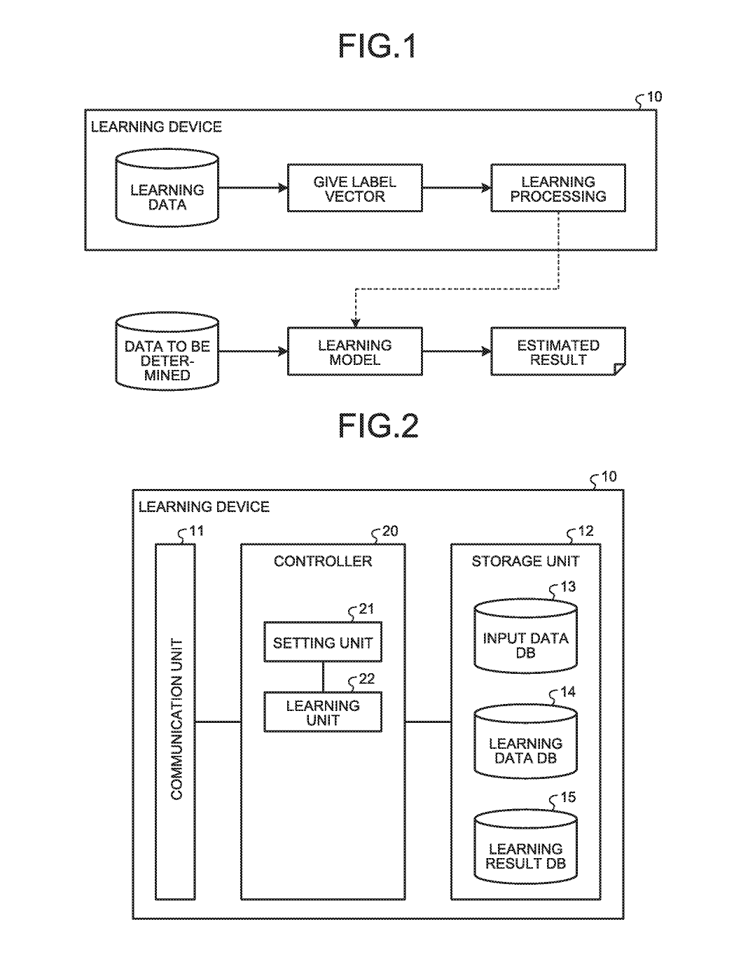

FIG. 1 is a diagram illustrating a whole example of a learning device in accordance with a first embodiment. As illustrated in FIG. 1, a learning device 10 in accordance with the first embodiment executes determination processing (learning processing) using deep learning (DL) and the like after giving a score to a label of learning data, and learns a neural network (NN) and the like using the score so that the learning device 10 can correctly determine (classifies) the learning data. After that, the learning device 10 uses a learning model to which a learning result is applied so as to implement estimation of an exact event (label) of data to be determined. Examples of the learning data can include various kinds of data such as images, videos, documents, and graphs.

For example, the learning device 10 is a computer device that learns a learning model including an NN, and learns a learning model including an NE using data to be learned and one or a plurality of labels that is/are given to learning data serving as data to be learned.

Generally, a label determined on corresponding data for learning of a learning model including an NN is held as a matrix. However, algorithm of a used support vector machine (SVM) and the like needs to decide one label, and normal distribution is assumed for a label vector with respect to corresponding data. Thus, learning algorithm is also made on the assumption of normal distribution, and learning where a plurality of labels that do not have normal distribution are set has not been executed.

These facts create a need for enabling a label that is not only a label 1 but also label 2 to be learned. The learning device 10 in accordance with the first embodiment adds a label probability value to corresponding data so as to pair expanded label vectors, and defines the data as an output target value of DL. In other words, the learning device 10 gives a label vector as a condition for each label to corresponding data, and defines an evaluation function of optimization as a measure of whether conditions of all labels are consistent so as to collectively learn even an exclusive label. In the present embodiment, if applicable to a label 1, “Label 1 is ∘ (round)” may be described. If not applicable, “Label 1 is × (x-mark)” may be described.

Functional Configuration

FIG. 2 is a functional block diagram illustrating the functional configuration of the learning device 10 in accordance with the first embodiment. As illustrated in FIG. 2, the learning device 10 includes a communication unit 11, a storage unit 12, and a controller 20.

The communication unit 11 is a processing unit that controls communication with the other device, and is, for example, a communication interface. For example, the communication unit 11 receives an instruction to start processing from a terminal of a manager. The communication unit 11 also receives data to be learned (input data) from a terminal and the like of a manager, and stores the data to be learned in an input data database (DB) 13.

The storage unit 12 is an example of a storage device that stores therein a computer program and data, and is, for example, a memory and a hard disk. This storage unit 12 stores therein the input data DB 13, a learning data DB 14, and a learning result DB 15.

The input data DB 13 is a DB that stores therein input data to be learned A label may be set to data stored in the input data DB 13 by manpower and the like, and may be unset. Data can be stored by a manager and the like, and the communication unit 11 can receive and store the data.

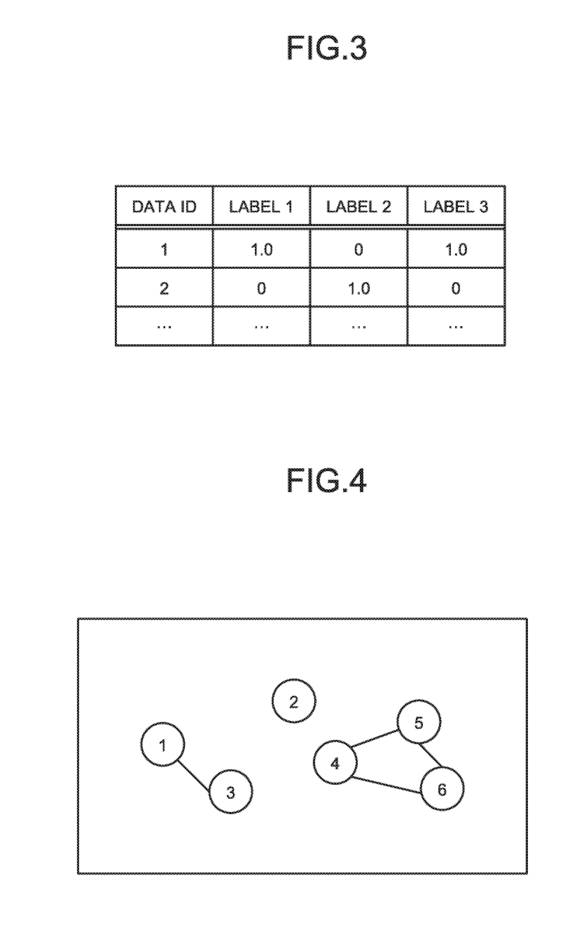

The learning data DB 14 is a DB that stores therein supervised data to be learned. Specifically, in the learning data DB 14, the controller 20, which will be described later, associates input data stored in the input data DB 13 with labels set to the input data and stores the associated input data and labels. FIG. 3 is a diagram illustrating an example of information stored in the learning data DB 14. As illustrated in FIG. 3, in the learning data DB 14, “data identification (ID), a label 1, a label 2, and a label 3” are associated with one another and stored. Each label is an exclusive label, and, for example, a label 1 is a cat-lover, a label 2 is a dog-lover, and a label 3 is a bird-lover. In other words, each of the labels can be established simultaneously.

The example of FIG. 3 illustrates that a label vector representing “1,0, 0, and 1.0” as “labels 1, 2, and. 3” is set to data with data ID “1”. In other words, labels 1 and 3 are set to the data 1. The dimension number and the numerical value are an example, and may be changed and set optionally.

The learning result DB 15 is a DB that stores therein a learning result. For example, the learning result DB 15 stores therein a determination result (classification result) of learning data performed by the controller 20 and various kinds of parameters learned by machine learning and DL.

The controller 20 is a processing unit that controls the whole processing of the learning device 10, and is, for example, a processor. This controller 20 includes a setting unit 21 and a learning unit 22. The setting unit 21 and the learning unit 22 are an example of a process executed by an electronic circuit included in a processor or the like, or by a processor, for example.

The setting unit 21 is a processing unit that gives a label vector to each input data so as to generate learning data and stores the generated learning data in the learning data DB 14. Specifically, the setting unit 21 determines correlation between labels. When there is no correlation, the setting unit 21 assumes that each label is independent and sets a label vector to which each label is set. By contrast, when there is a correlation, the setting unit 21 optimizes distribution of each label and sets a label vector where a value based on the optimized distribution is set to each label.

The following describes various kinds of methods in specific terms. It is assumed that a sufficient number of data are arranged for each label. The setting unit 21 determines correlatively. Specifically, the setting unit 21 calculates the ratio of ∘ to × (applicable/not applicable) of a label 1 in all. For example, the setting unit 21 calculates, in all of the data, the ratio of data that is applicable to the label 1 to data that is not applicable to the label 1.

Subsequently, the setting unit 21 calculates, in the data that is o (applicable) to a label 2, the ratio of o to x (applicable/not applicable) of the label 1. For example, the setting unit 21 calculates, in the data that is applicable to the label 2, the ratio of data that is also applicable to the label 1 to data that is not applicable to the label 1. When the difference in ratio is less than a threshold, the setting unit 21 determines that the labels 1 and 2 are independent. By contrast, when the difference in ratio is equal to or greater than a threshold, the setting unit 21 determines that there is correlation between the labels 1 and 2.

Examples of the case where there is correlation between labels include such a case that a label 1 represents age equal to or greater than 20 or age less than 20 and a label 2 represents age equal to or greater than 30 or age less than 30, and data may change from the label 1 to the label 2 and may become applicable to both the labels 1 and 2 in the middle of a process. In this case, if both labels are simply defined as label 1, learning might be difficult. For example, when an NN having a simple network configuration (having a small number of layers and units) is used, a learning model may be a model in which the ratio of data applicable to one correlated label rises and the ratio of data applicable to the other correlated label falls. By contrast, when an NN having a complex network configuration (having a large number of layers and units) is used, correlated labels are independently determined, but learning takes a lot of time and a huge amount of learning data is also needed.

The result of organizing correlation is illustrated in FIG. 4. FIG. 4 is a view illustrating the correlation between labels. FIG. 4 illustrates the correlation between labels 1 and 6. In FIG. 4, the labels 1 and 3 are correlated, the labels 4, 5, and 6 are correlated, and the label 2 is independent. In this case, about the label 2 of corresponding data, if applicable, the setting unit 21 sets “1.0” regardless of the other labels. If not, the setting unit 21 sets “0.0”.

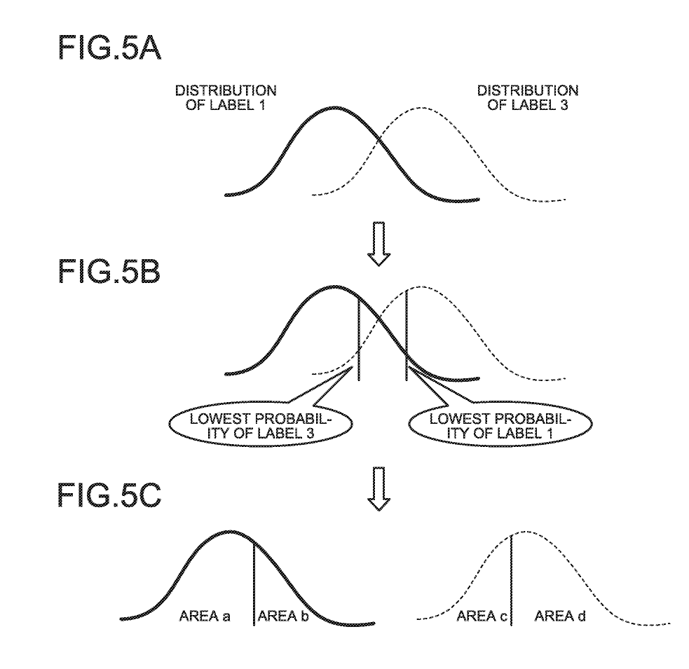

The following describes the settings of a value of each label that is correlated. In this embodiment, relation between labels 1 and 3 is described as an example. FIGS. 5A to 5C are views illustrating an example of label settings. As illustrated in FIGS. 5A to 5C, the setting unit 21 assumes that distribution of data that is applicable to the label 1 and distribution of data that is applicable to the label 3 are distribution illustrated in FIG. 5A. Subsequently, as illustrated in FIG. 5B, the setting unit 21 sets the lowest probability of each distribution. This lowest probability is the lowest value of probability that a user sets, and occurrence probability where the edge of each distribution can be determined to be something like noise is set.

Subsequently, the setting unit 21 optimizes distribution so that the ratio of each area illustrated in FIG. 5C and the ratio of data can be the same. In the embodiment, “area a:area b=data also applicable to the label 3 among data applicable to the label 1:data not applicable to the label 3 among data applicable to the label 1”. In addition, “area c: area d=data also applicable to the label 1 among data applicable to the label 3:data not applicable to the label 1 among data applicable to the label 3”.

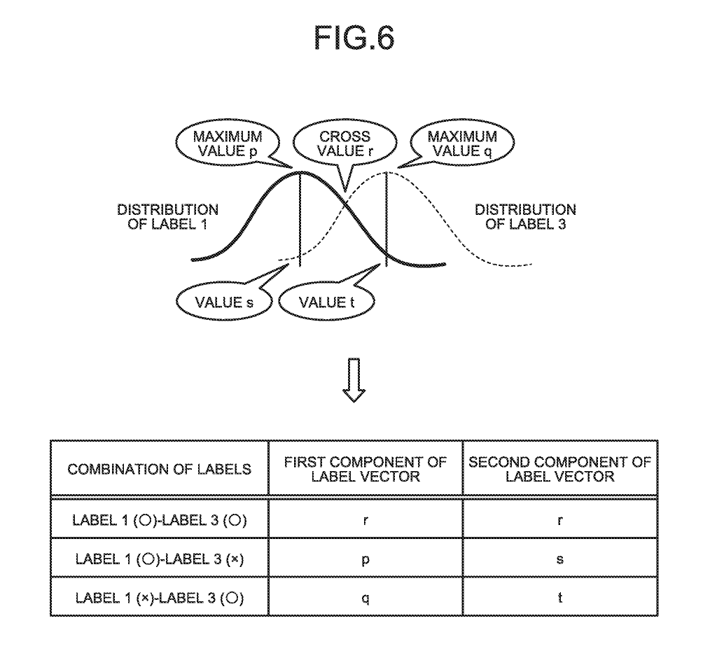

After that, the setting unit 21 generates a label vector based on the optimized distribution. FIG. 6 is a view illustrating an example of generating label vectors. As illustrated in FIG. 6, the setting unit 21 specifies a maximum value p of the label 1, a minimum value t of the label 1, a maximum value q of the label 3, a minimum value s of the label 3, and a cross value r from distribution after normalization.

The setting unit 21 gives, to data that is applicable to both the labels 1 and 3, a label vector “label 1=r, label 3=r” where r is set to a first component of the label vector and r is set to a second component of the label vector. In addition, the setting unit 21 gives, to data that is applicable to the label 1 but is not applicable to the label 3, a label vector “label 1=p, label 3=s” where p is set to a first component of the label vector and s is set to a second component of the label vector. Furthermore, the setting unit 21 gives, to data that is not applicable to the label 1 but is applicable to the label 3, a label vector “label 1=label 3=t” where q is set to a first component of the label vector and t is set to a second component of the label vector.

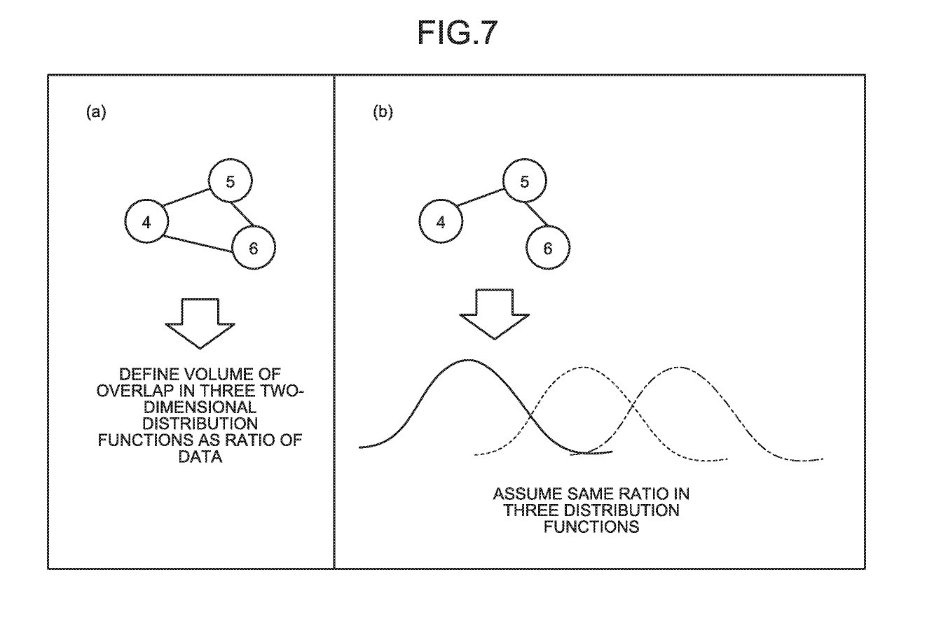

In the embodiment, the example where two labels are correlated, but a label vector can be generated with the same method even when three or more labels are correlated. FIG. 7 is a view illustrating another example of label settings. As illustrated in (a) of FIG. 7, when the labels 4, 5, and 6 are correlated with one another, the setting unit 21 defines the volume of overlap in three two-dimensional distribution functions as the ratio of data, and executes the processing from FIGS. 5A to 5C to FIG. 6 described above. As illustrated in (b) of FIG. 7, the labels 4 and 5 are correlated, the label 5 and the label 6 are correlated, and the labels 4 and 6 are not correlated, the setting unit 21 assumes the same ratio in the three distribution functions so as to execute the processing from FIGS. 5A to 5C to FIG. 6 described above.

In this manner, the setting unit 21 can calculate a value based on the distribution and occurrence probability of data that is applicable to each of the correlated labels, generate a label vector to which the value is set, and set the generated label vector to corresponding data.

Referring back to FIG. 2, the learning unit 22 is a processing unit that executes learning of a learning model including an NN using learning data stored in the learning data DB 14 and stores a learning result in the learning result DB 15. In the example of FIG. 3, the learning unit 22 receives, for data with the ID 1, a label vector “label 1=1.0, label 2=0, and label 3=1.0” as input, and executes learning.

Flow of Processing

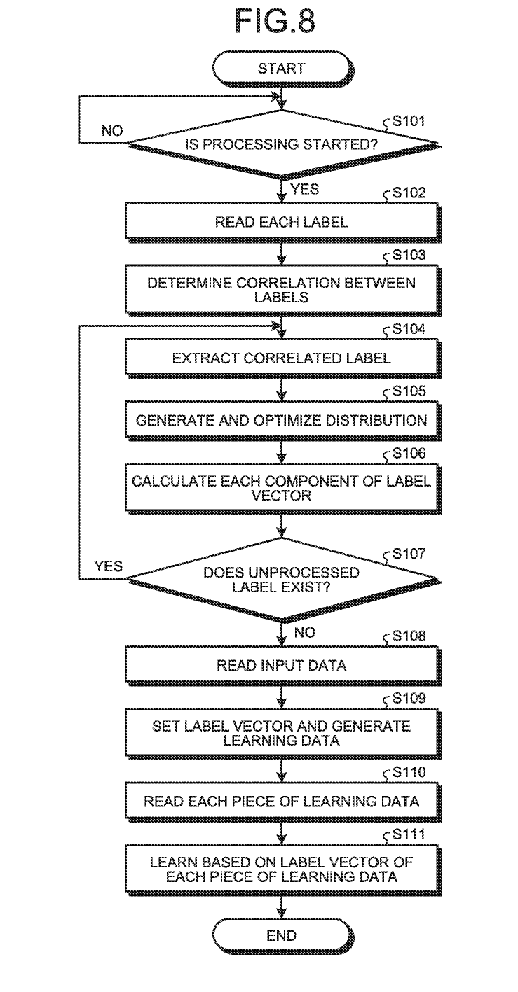

The following describes setting processing of the label vector described above. FIG. 8 is a flowchart illustrating a flow of processing.

As illustrated in FIG. 8, when input data is received and stored in the input data DB 13, the setting unit 21 receives instruction at the start of processing (Yes at S101), and reads each label to be set (S102). A label to be set can be specified by a user designation, and can be, when a label is preliminary set to input data, specified by reading the label.

Subsequently, the setting unit 21 determines correlation between labels with the method described above (S103), and extracts a correlated label (S104). After that, the setting unit 21 generates distribution of labels and optimizes the distribution using the method in FIGS. 5A to 5C to FIG. 6 (S105). The setting unit 21 calculates each component of a label vector based on the optimized distribution using the method illustrated in FIG. 7 (S106).

When a correlated label with processing at S104 to S106 unprocessed exists (Yes at S107), the setting unit 21 repeats processing at 5104 and after. By contrast, when a correlated label with processing at S104 to S106 unprocessed does not exist (No at S1(7), the setting unit 21 reads each input data from the input data DB 13 (S108).

The setting unit 21 generates learning data where a label vector is set to each input data, and stores the generated learning data in the learning data DB 14 (S109). Specifically, the setting unit 21 sets, about a label that is not correlated and is independent, a value as it is (applicable (1.0) or not applicable (0.0)), and generates, about a correlated label, a label vector to which a value generated at S106 is set and gives the generated label vector to each input data.

After that, the learning unit 22 reads each piece of learning data from the learning data DB 14 (S110), and executes learning based on a label vector of each piece of learning data (S111).

Effect

As described above, the learning device 10 can resolve, using a label vector (decimal label) to which probability and the like based on distribution of data are set, a negative effect caused by aggregating labels for one piece of data into one label in response to a limitation that one label can be used for learning in learning of a learning model including an NN. Thus, the learning device 10 can reduce deterioration in determination speed and deterioration in determination accuracy of a learning result caused by aggregating labels.

The following describes an experiment result obtained by comparing the method of the first embodiment with the related method. Conditions of the experiment will be described. In the experiment, ten-dimensional vector data is generated, and a random number (0 to 1) is generated in each dimension so as to generate 1,200 pieces of data. A label is generated depending on whether each component is equal to or greater than 0.5. Specifically, when a first component is equal to or greater than 0.5, a label 1 is given. When each of the first, fifth, and seventh components is equal to or greater than 0.5 and the other components are less than 0.5, labels 1, 5, and 7 are given. When correlatively is determined, it is determined that all labels are independent.

The experiment is performed with the method (first embodiment) of the first embodiment, the method (exclusive labeling) for giving a new label to a combination of exclusive labels and generating 1,024 labels, and the method (multiple classifiers) in which a classifier is prepared for each label and 10 classifiers are used, and results of the experiment are compared.

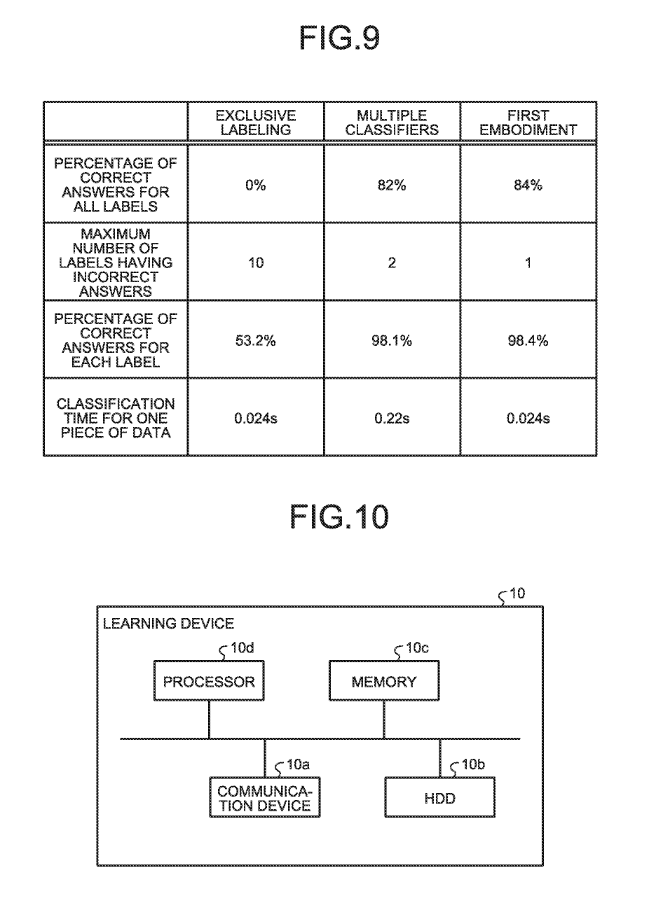

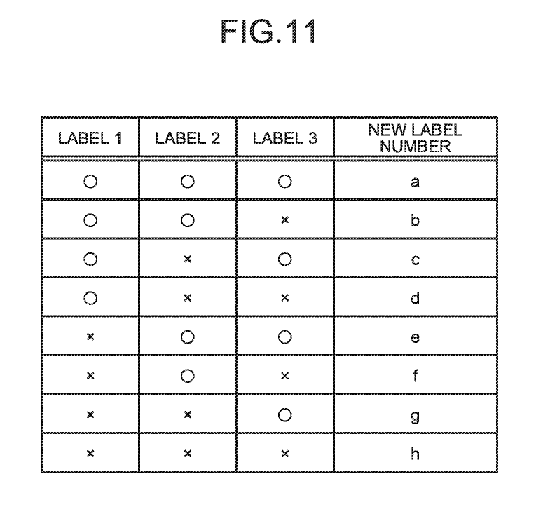

FIG. 9 is a diagram illustrating the experiment results. FIG. 9 indicates, about each of the first embodiment, the exclusive labeling, and the multiple classifiers, a percentage of correct answers for all labels, the maximum number of labels having incorrect answers, a percentage of correct answers for each label, and a classification time for one piece of data. The percentage of correct answers for all labels indicates a percentage where answers of all labels are correct. The maximum number of labels having incorrect answers indicates the maximum number of labels having incorrect answers in the data that does not have correct answers for all labels where answers of all labels are correct. The percentage of correct answers for each label the sum of a percentage where an answer of each label is correct. The classification time for one piece of data as a time taken for processing one piece of data to be classified.

As illustrated in. FIG. 9, in the exclusive labeling, there is no data where answers of all labels are correct, there is a case where answers of all labels are incorrect, and a percentage of correct answers is also low. Between the multiple classifiers and the first embodiment, there is no significant difference in percentage of correct answers. However, the multiple classifiers have taken processing time ten times greater than that in the first embodiment. Thus, the first embodiment can implement both improvement in percentage of correct answers and shortening of processing time.

[b] Second Embodiment

Although the embodiment of the present invention has been described above, various kinds of embodiments other than the embodiment described above may be implemented.

Settings

In the embodiment described above, the example where a value based on correlation and distribution is set to a label vector has been described, but this is not limiting. For example, in the exclusive label, the following values can be set: a value set by a user and the like, a value based on a past history and the like, and a static value such as a statistically calculating value.

Aggregation

For example, in the correlated labels, the learning device 10 does not set a value to each label based on distribution like the first embodiment, but can set any of the labels. When this case is explained with the example of FIG. 4, the learning device 10 can learn by giving a label vector where only either of the correlated labels 1 and 3, the label 2 that is not correlated with the other labels, and either of the correlated labels 4 to 6 are set to data. In the first embodiment, the learning device 10 sets “0.6, 1.0, 0.4, 0.2, 0.3, and 0.5” and the like as a label vector “labels 1, 2, 3, 4, and 5”, but this is not limiting. The learning device 10 can set “1.0, 1.0, 0.0, 0.0, 1.0, and 0.0” and the like. This manner can reduce the occurrence of contradiction between learning data and an aggregation label and deterioration in learning accuracy while implementing shortening of processing time taken for aggregating labels.

Labels to be used can be preliminary organized without using all labels. For example, a plurality of similar labels can be aggregated into one label. Correlated labels can be collected so as to generate a plurality of groups, and any desired one of the labels can be selected from each group. This manner can reduce deterioration in learning accuracy while implementing shortening of processing time for aggregating labels.

System

Except as otherwise specifically described, any desired modifications can be made on processing procedures illustrated in the specifications and drawings, control procedures, specific names, and information including various kinds of data and parameters. Specific examples, distribution, numerical values, and the like described in the embodiments are an example, and any modifications can be made.

Each component in each of the illustrated devices is something functionally conceptual, and is not necessarily configured physically as illustrated. In other words, a specific embodiment of distributing/integrating each of the devices is not limited to the illustrated one. In other words, all of or a part of the devices can be configured to be functionally or physically distributed/integrated in a certain unit depending on various kinds of loads, use situations, and the like. In addition, all of or a certain part of the processing functions executed by each of the devices may be implemented by a central processing unit (CPU) and a computer program analyzed and executed by the CPU, or may be implemented as hardware of the wired logic.

Hardware

FIG. 10 is a diagram illustrating a hardware configuration example. As illustrated in FIG. 10, the learning device 10 includes a communication device 10a, a hard disk drive (HDD) 10b, a memory 10c, and a processor 10d. Each of the units illustrated in FIG. 10 is mutually connected through a bus and the like.

The communication device 10a is a network interface card and the like, and communicates with the other server. The HDD 10b stores therein a computer program causing functions illustrated in FIG. 2 to be operated and a DB.

The processor 10d reads a computer program that executes the same processing as that of each processing unit illustrated in FIG. 2 from the HDD 10b and the like and loads the computer program to the memory 10c so as to operate a process executing each function illustrated in FIG. 2 and the like. In other words, this process executes the same function as that of each processing unit included in the learning device 10. Specifically, the processor 10d reads a computer program having the same function as those of the setting unit 21 and a learning unit 22 from the HDD 10b and the like. The processor 10d executes a process executing the same processing as that of the setting unit 21, the learning unit 22, and the like.

In this manner, the learning device 10 operates as an information processing device that reads and executes a computer program so as to execute a learning method. In addition, the learning device 10 causes a medium reading device to read the computer program described above from recording media, and executes the read computer program so as to implement the same function as that in the embodiments described above. A computer program in the other embodiments is not limited to the computer program executed by the learning device 10. For example, when the other computer or server executes a computer program and when the other computer and server cooperate with each other and execute the computer program, the present invention is applicable in the same manner.

This computer program can be distributed through a network such as the Internet. In addition, this computer program may be recorded in computer-readable recording media such as a hard disk, a flexible disk (PD), a compact disc read-only memory (CD-ROM), a magneto-optical disk (MO), and a digital versatile disc (DVD), and may be read from the recording media by a computer so as to be executed.

According to one aspect of an embodiment, learning with learning data to which an exclusive label is given can be executed.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed s:

1. A non-transitory computer-readable recording medium storing therein a learning program that causes a computer to execute a process comprising:
setting a label vector having one or a plurality of labels as components to corresponding data to be learned; and
learning a learning model including a neural network using the data to be learned and the label vector correspondingly set to the data to be learned.

2. The non-transitory computer-readable recording medium according to claim 1, wherein the process further includes:
generating the label vector based on correlation between labels, each of the labels being correspondingly set to the data to be learned; and
setting the label vector to the corresponding data to be learned.

3. The non-transitory computer-readable recording medium according to claim 1, wherein the process further includes:
determining, about a plurality of labels that are set to the data to be learned, correlation between the labels;
setting, about a label that is not correlated with any labels in the labels, a value indicating whether to be applicable to the label, and generating, about correlated labels, the label vector to which a value based on the correlation is set; and
setting the label vector correspondingly to the data to be learned.

4. The non-transitory computer-readable recording medium according to claim 3, wherein the process further includes:
generating, about the correlated labels, distribution of data that is applicable to each label; and
generating the label vector from occurrence probability based on the distribution of data.

5. A learning method comprising:
setting a label vector having one or a plurality of labels as components to corresponding data to be learned; and
learning a learning model including a neural network using the data to be learned and the label vector correspondingly set to the data to be learned, by a processor.

6. A learning device comprising:
a processor configured to:
set a label vector having one or a plurality of labels as components to corresponding data to be learned; and
learn a learning model including a neural network using the data to be learned and the label vector correspondingly set to the data to be learned.
